(19) United States
(12) Patent Application Publication
(10) Pub. No.: US 2012/0167551 A1
(43) Pub. Date: Jul. 5, 2012

(54) ELECTRIC TURBINE BYPASS FAN AND COMPRESSOR FOR HYBRID PROPULSION

(75) Inventor: Richard H. Lugg, Falmouth, ME (US)

(73) Assignee: SONIC BLUE AEROSPACE, INC., Portland, ME (US)

(21) Appl. No.: 13/419,562

(22) Filed: Mar. 14, 2012

Related U.S. Application Data
(63) Continuation of application No. 11/828,030, filed on Jul. 25, 2007.
Application No. 11/828,030 is a continuation-in-part of application No. PCT/US2007/000307, filed on Jan. 9, 2007.
(60) Provisional application No. 60/757,369, filed on Jan. 9, 2006.

(51) Int. Cl. F02K 3/04; F01D 1/04

(52) U.S. Cl. 60/226.1; 415/66

(57) ABSTRACT

An electric turbine compressor fan for hybrid propulsion wherein the compressor contains one or more rotor stages (compressor and diffuser), each being driven by one or more electric ring motors, such that the compressor rotor stages are designed and tuned more precisely to the compression ratio to be attained within the turbine design operating characeristics, thrust requirements and flight envelope.

### FIELD OF THE INVENTION

The invention relates to an electric turbine bypass fan and compressor for hybrid propulsion.

### BACKGROUND OF THE INVENTION

Optimization of thermal power in turbine engines starts with the optimization of the thermodynamic cycle scheme, i.e. the thermodynamic relations of cycle media in the process of power production. In accordance with Camas Rule of Thermodynamics, it involves the introduction of fuel heat input at maximum possible temperature, compression and expansion, at maximum compressor and turbine efficiency, along with the release of non-convertible heat to ambient temperature at minimum loss.

Gas turbine engines, and the devices that are powered by gas turbine engines, are limited in overall design and performance by mechanical, material, and thermodynamic laws. They are further constricted by the design limitations of the three elements that make up the baseline design of gas turbine engines: the compressor, the combustor and the turbine. In turbines for aircraft, these three engine sections are contained inside of the outer turbine casing and are centered on a load bearing drive shaft that connects the turbine (on the portion of the drive shaft) with the compressor (on the forward portion of the drive shaft). Typically the drive shaft is a twin or triple spool design, consisting of two or three concentric rotating shafts nested one inside the other. The different spools allow the turbine assembly and the compressor assembly, each of which is connected to one of the spools of the drive shaft, to rotate at different speeds: the turbine is optimized to run at one particular speed for combustion and thrust processes, and the compressor is optimized at a different speed to more efficiently compress incoming air at the inlet face. The difference in speeds of the spools Is typically accomplished by reduction gears.

The compressor assembly consists of several compressor stages, each of which is made up of a rotor and a diffuser. The rotor is a series of rotating airfoil blades, or fans (attached to the shaft), which converge the air, i.e., compressing the volume of air on the intake side of the blade into a smaller volume of air at exit. Adjacent to each rotor is a diffuser. The diffuser is a fixed, non-rotating disc of airfoil stators that expands the volume of the incoming high pressure air, now at higher velocity after exiting the adjacent rotor, by having the air pass from a narrow opening on the intake side of the diffuser into a gradually enlarging chamber that slows and lowers the pressure of the air. Each compressor stage is made up of a compressor rotor and a diffuser disc. There are as many stages of the compressor as are required to get the air to the required air temperature and compression ratio (in high performance aircraft turbines usually in between 40:1 to 65:1 dependent on combuster design, flight and speed envelope and turbine thrust requirements) prior to entering the combustor.

In the combustor, the higher pressure and higher temperature air mixes in a swirl of hot liquid fuel and ignites to form a controllable flame front. The flame front expands as it combusts, rotating and driving turbine blades as the flame front exits the engine. The turbine assembly consists of several sets of rotating turbine blades connected to the drive shaft and angled so that the thrust of the flame front causes the blades to rotate. The turbine blades, being connected to the drive shaft, cause the drive shaft to rotate and thus the compressor blades to rotate.

Turbomachinary design must be optimized in terms of flow efficiency, high temperature blade cooling methods, rotor speed, and turbine compressor driving connections on the basis of sound rotor dynamics. Many technical specialties are interwoven in a design; e.g., axial flow air compressors involve the intersection of thermodynamics, aerodynamics, structures, materials, manufacturing processes, and controls. Typically, selection of rotational speed is complex in current turbomachinary designs using drive shafts. It largely depends on the balance of the requirements of the three major components on the common shaft—the by-pass fan, compressor, and turbine. Because of requirements for differential compression and associated rotational speeds, the drive shaft is multi-segmented with one shaft running inside another. In an electric turbine by-pass fan and compressor system, eliminating the drive shaft leads to a more refined approach to differential staging of the fan to the compressor, and the interrelation of thermodynamics and efficiencies with interstages in multi-axial compressor designs.

The overall layout of multiple compression stages in turbomachines is driven by the objective of maximizing the performance of the first transonic turbine stage and its associated impact on subsequent turbine stages and their efficiences of power extraction from the combusting gases. Electric turbo compressor-compounding eliminates the mechanical coupling to the engine crankshaft, thereby eliminating the need for a crankshaft forward of the combustor. This provides additional flexibility in packaging the thermodynamic cycle scheme and its design in the turbine. The compressor-compounding also provides more control flexibility in that the amount of power extracted can be varied, allowing for control of engine thermodynamics, pressure ratio, fuel consumption, mass airflow, entropy and endothermic reactions and nitrogen oxide (NOX) and carbon dioxide (CO2) formation. Moreover, the compressor-compounding can be operated as a ring-generator with embedded systems controls for switching and generate large amounts of power for other electric payloads on an airframe.

Pressure Ratio compressibility is to be matched to multiple design point operating conditions. Because the compressor of the present invention has one or more rotor stages (compressor and diffuser), each being driven by one or more electric ring motors, the compressor rotor stages are designed and tuned more precisely to the compression ratio to be attained within the turbine design operating characteristics, thrust requirements and flight envelope. This allows for optimal aerodynamic design and efficiencies of the rotor stages in the compressor and subsequently the possibility of fewer stages needed to achieve the required compression ratios for operation of the turbine. The result is a significant potential in weight savings. Because each compressor rotor may be driven independently and at different speeds, the engine may be used more efficiently at different stages of the flight envelope.

The impact of the present invention, its innovation and the unique aspect it can impose on current turbomachinary layout design, thermodynamic cycles, and thermal efficiencies, which can improve power production, is dramatic.

### SUMMARY OF THE INVENTION

It is an object of the invention to design and tune the compressor rotor stages more precisely to the compression ratio to be attained within the turbine design operating characteristics, thrust requirements and flight envelope.

It is another object of the invention to provide optimal aerodynamic design and efficiencies of the rotor stages in the compressor. Another object of the present invention is to achieve significant weight savings for operation of the turbine.

An additional object of the present invention is to use the engine more efficiently at different stages of the flight envelope. Still another object of the invention is to provide conductive pathways to power the ring motor magnetics via the generator location.

Yet another object is to provide a novel and unique configuration of forming electrical conductive pathways in rotational turbomachinary components.

Another object is to reduce the number of rotor/diffuser compressor stages.

### BRIEF DESCRIPTION OF THE ATTACHED DRAWING FIGURES

The present invention is shown in the appended drawing figures of which:

FIG. 1 is a graph of temperature versus cycle

FIG. 1B is a graph as depicted in FIG. 1 and an illustration of the gas compression process

FIG. 2 Is a corresponding illustration of the gas compression process

FIG. 3 is an equation and legend of vehicle weight, magnet coil, levitation, etc.

FIG. 3B shows the magnetic drag versus aerodynamic drag

FIG. 4 is an equation depicting the intersection of flight condition, design, and atmospheric properties

FIG. 5 shows the steady and unsteady states of the invention described herein

FIG. 6 shows the streamtube and other components as a function of the cycle shown

FIG. 7 depicts the guide vanes, rotor and stator with corresponding notations regarding tangential velocity increase

FIG. 8 shows the stability boundary of Tc versus m

FIG. 9 is a depiction of the stator and rotor with notations regarding tangential velocity

FIG. 10 is a graph of A/A versus M

FIG. 11 is a depiction of the preferred embodiment of the present invention

FIG. 12 show a configuration of the compressor stator and rotor positions in one embodiment of the present invention

FIG. 13 is a graph depicting the pressure and velocity profiles through a mechanical multi-stage axial compressor.

FIG. 13a s a graph depicting the pressure and velocity profiles through an electrical multi-stage axial compressor.

FIG. 14 shows another configuration of stator and rotor positions in an embodiment of the present invention

FIG. 15 is a graph showing temperature versus entropy curves for various locations within the present invention.

### DETAILED DESCRIPTION OF THE PREFERRED EMBODIMENTS

For the purposes of promoting an understanding of the principles of the Invention, reference will now be made to the embodiments of the present invention illustrated in the drawing figures briefly described above. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The key operations of the electric by-pass fan and electric turbocompressor-compounding compressor turbine system are that they are disengaged or engaged electrically, so that combustion cycles, compressor ratios, compressor cooling, thrust, and electric generation can be arranged and optimized for high thermodynamic and combustion efficiencies across the entire flight envelope, regardless of altitude, air density, temperature and other operating constraints.

Compared to current turbine engine systems for aerospace applications, the electric by-pass fan and/or electric turbocompressor-compounding system is designed to operate at ideal compression, combustion and burn efficiencies, and at higher temperatures, throughout a broader range of operation, from low subsonic (Mach 0.3) to high supersonic (Mach 2.8+) flight speeds. This is due to the magnetic, thermodynamic, mechanical and electric technologies that enable electric compression and by-pass fan operation.

The pressure ratio compressibility can be matched to multiple design point operating conditions. The electric by-pass fan has one or more low-bypass fans and/or electric compressor stages making up a compound compression system. The air flows into the electric by-pass fan and/or the electric compressor in an axial direction through a series of rotating rotor blades, and stationary stator vanes that are concentric with the axis of rotation. The flow path in the axial electric ring by-pass fan and the electric multi compressor stages (turbocompressor-compounding system) decreases in cross-sectional area in the direction of flow. The decrease in cross-sectional area is in proportion to the increased density of the air as the compression progresses from stage to stage

The preferred embodiment of the present invention has one or more stages comprising a compressor and diffuser. Each stage is driven by one or more electric ring motors. The compressor rotor stages are designed and tuned more precisely to the compression ratio to be attained within the turbine design operating characteristics, thrust requirements and flight envelope. They are independent form one another, which offers greater flexibility in the generation of compression, maximum pressure ratio attained, aerothermodynamic generation heating ratios, and high endothermic and entropic combustion and fuel burn oxidation optimization, ultimately being passed on in the combustion cycle to a highly efficient fuel burn. This allows specifically for optimal aerodynamic design and efficiencies of the rotor stages in the compressor, and accordingly, the possibility of fewer stages needed (hence potential significant weight savings) to achieve the required compression ratios for operation of the turbine. Because each compressor rotor can be driven independently and at different speeds, the engine may be used more efficiently at different stages of the flight envelope as a combustion turbine machine.

### The Electric Ring Compressor

The use of a compressor stage enables the compressor rotor to generate higher torque than a shaft driven compressor rotor (wherein the compressor fan rotors are being driven from the tip of the blade at the circumference of the rotor rather than from the root or hub, and the leverage moments required to overcome mechanical loading are in an order of magnitude less) and enables the compressor stage to optimized typically constrained design variables, including those set forth below;
Hub/tip design ratios at the inlet of the compressor stage;
Variation of blade geometry, blade width, and resultant mean blade axial length velocity and stage loading, for the consequent improvement of mass airflow, air density and temperature rise;
Optimization of flow area and associated dimensions of the flow path from one compressor stage to the next;
Blade number and blade spacing;
Chord to height ratios, CM, can be increased due to higher stage loading conditions;
Stage loading coefficient, diffusion factors adjusted to maximize the axial length velocity and blade Mach number;
Multi-speed stages allow for additional compression of the fluid flow direction between the rotor and the fixed stator, wherein the airfoil profile is distributed differently across the blade airfoil camber line to reduce drag losses and raise stage coefficient efficiency;
Increase of C/H reduces blade number and blade spacings of the airfoils thus reducing flight weight of the component stage but maintaining compression coefficient efficiencies;
Reduction of the mean radius of the flow radius, defined as the average of the tip radius and hub radius;
Inlet flow angle can be marginalized to drag a broader chord airfoil at a shorter blade length for increased efficiency.
Reduction of the number of stages to achieve the same compression ratios required for combustion;
Stage numbers being reduced allows for a compressor design to effect mean-line diffusion factors “D”, mean-line solidity “@”, and polytropic efficiency “E”, thus effecting the overall efficiency of the compressor machine as a compounding medium and consequently the overall compressor ratio across the machine. Higher compression ratios (above 30:1) offer greater efficient fuel burn, reduced power and drag losses and greater overall thrust in a turbomachine. The preferred embodiment of the present invention raises polytropic efficiency above 90%, of which state-of-the-art designs do not exceed (high performance military low-bypass turbofans efficiency is customarily at 86-88%);
in current state-of-the-art compressor designs, stage inlet Mach number decreases through a multi-stage compressor, and stage pressure ratios of repeating-rows in the repeating stages also decrease. In an electric turbine compressor design with rotor stages operating at different Mach numbers, Mach number can be maintained or increased, hub/tip ratio reduced, axial Mach number increased, and the total change in temperature across each stage can be raised to cause a positive effect on the atomization of the fuel as the compressed air (and thus heated air) enters the combustor;
inlet guide vanes are designed to add swirl in the direction of rotor motion to lower the Mach number of the flow relative to the rotor blades. In the preferred embodiment of the present invention, the first rotor stage velocity, and angular vector are adjusted to match more closely the inlet Mach number. Energy conservation is increased as the mass flow moves to the second compressor stage. Subsequently the second rotor stage Is set at the optimum velocity to match the falling Mach number due to swirl and the velocity vector of the preceding rotor stage in the electric compressor, however, across the electric compressor energy is conserved, compression ratio raised to a higher level per each given unit of energy compared to current art of multi-axial compounding compressors using drive shafts;
Surge and choke lines that bind the operating range of a gas turbine engine are set for compressor aerodynamic steady state performance maximization and define the end points of operation for the compressor within the turbomachine. Typically, to assure compressor stability during operation, an engine compressor is designed with a surge margin. Large surge margins as a design point for steady performance and operation are employed due to transient conditions that move the compressor operating point (compression ratio, mass air flow, mass and stage loading, temperature rise and turbine/compressor rise ratio) close to the surge line. Large surge margins place the compressor operating line and end points far from the surge line and preclude the operation at the desired peak pressure rise or maximum efficiency region of the compressor and the turbine. Two types of instability can develop in a compressor; surge and stall. Surge is a global asymmetric oscillation of flow through the compressor which can reverse the flow during a portion of the surge cycle. These oscillations can result in engine damage from the unsteady thrust load or the Ingestion of combustion gases into the compressor and engine inlet In severe surge cycle, the reversed flow through the compressor can extinguish combustion, resulting in a “flameout”, or total loss of power. Rotating stall is a local flow deficit that rotates around the compressor annulus. This flow deficit, or cell, is a region in which the local mass flow is near zero. Gas turbine engine steady performance can be optimized and improved. Rotating stall may consist of one or more multiple cells that rotate around the compressor at an angular speed which is a fraction of the rotor speed. This instability results in a loss of compressor performance that may require the shut down of the engine to clear. Operating a compressor in rotating stall can contribute to fatigue damage of the blading resulting from the rotating stall unsteady aerodynamic loading. Also the loss in compressor performance during rotating stall can move the compressor to the operating point where surge is intitiated by the operating point crossing the surge line. In the preferred embodiment of the present invention, variable speed compressor stages operates at different speeds and therefore adjust the velocity of flow, angular velocity, mach number flow and its angular vector and shock, pressure ratio and compression efficiency, so that the surge margin, or compressor stall point, is reduced and controlled. Consequently operation at peak pressure rise is maintained and the surge point is moved closer to the maximum compressor efficiency operating point without crossing it into stall or surge conditions.
Rotor to rotor, each stage has an optimized RPM and velocity of flow Mach number set from one preceding stage to the next in the invention disclosed herein of an electric, axial flow compressor. The design point of the electric compressor is set to maintain velocity and pressure of exit flow from each stator (fixed vane) of a rotor stage to the follow on rotor stage, rotating at a different RPM, but set to the optimization pressure, temperature and Mach number of the flow to maximize pressure rise between the stages. The flow rate is lowered between the stages to improve the aerodynamic performance of the rotor, namely aerodynamic efficiency or stage efficiency. The stage efficiency of an adiabatic multistage compressor is defined as the ratio of the ideal work per unit mass of flow to the actual work per unit mass flow between the same total pressures. The other measure of efficiency which is beneficial in the preliminary design of compressors is the polytropic efficiency. The polytropic efficiency of an adiabatic compressor is defined as the ratio of the ideal work per unit mass to the actual work per unit mass for a differential pressure change. In the limit, as pressure ratio approaches on for a given stage, the stage efficiency approaches the polytropic efficiency. Axial flow compressors designed for jet engines in the 1980s have a polytropic efficiency of about 0.88, whereas the compressors of current art have polytropic efficiencies of about 0.90. The electric multiaxial ringmotor compressor discussed here, baseline design on polytropic efficiency improvements come from aerodynamic drag reductions from the magnetically levitated air bearing of the compressor stages and axial hub drag reduction (discussed later in this paper), as there is no hub nor shaft. Design estimates for polytropic efficiency improvements are in the range of 0.02-0.05, for potential improvements in the range of 0.92-0.95. In current art micro-flow energy, enthalpy and efficiency management cannot be done through the micro-management of the airflow between one compressor stage (rotor stage) and the next because every component is connected to a shaft. The present invention Is a multistage shaftless design or single stage shaftless electric compressor.
In the preferred embodiment of the electric multi-axial compressor of the present invention, every stator row is a slower moving airfoil blade row, thus having the capacity to add net energy to the flow, as well as acting as a conversion device to the flow, adding kinetic energy to the flow and raising the static pressure simultaneously of the flow.
Because compressor of the present invention has one or more rotor stages, each being driven by one or more electric motors, the compressor rotor stages are designed and tuned more precisely to the compression ratio to be attained within the turbine design operating characteristics, thrust requirements and flight envelope. This allows for optimal aerodynamic design and efficiencies of the rotor stages in the compressor with fewer stages needed to achieve the required compression ratios for operation of the turbine.
Because each compressor rotor may be driven independently and at different speeds, the engine may be used more efficiently at different stages of the flight envelope.
With the generator is enclosed within the hollow drive shaft, stationary diffuser stages (alternating between rotors) act as conductive pathways to power the ring motor magnetics at the outer rim of each compressor rotor. In this configuration, each compressor rotor stage is adjacent to an electrical conductive pathway diffuser stage and can be run independently of the others with motor controllers at the outer ring of each stage. This configuration of forming electrical conductive pathways in rotational turbomachinary components is also novel and unique. This configuration of the electrical compressor allows for aerodynamic optimization to meet compression ratios otherwise considered unachievable with a fixed drive shaft driven compressor.
Another advantage of the electrically driven compressor is that rotational speed of the rotor stages does not suffer from spool up or spool down time (the time spent increasing or decreasing the rotational speed of the drive shaft) as is the case in traditional turbine designs, and the speed of the compressor rotors can be more quickly adjusted to achieve optimum performance of the engine based on different flight conditions, airframe loads, and optimal combustion performance.
The load bearing surface for the compressor stages is now at the outer circumference of the compressor stages. This design configuration allows for the compressor rotors to be “loaded in compression,” which leads to a lower structural weight and more effective use of materials.
Additionally, with the drive shaft removed in the compressor section and fan section a “donut hole” appears in the center of the rotor, rotating components (rotor and stator) in the compressor section, and the fan of the engine are protected against “cyclic fatigue” producing load paths which result from the acceleration and deceleration of rotating machinery attached to drive shafts.
The configuration of the present invention not only provides thrust as bypass air around the combustor but also acts as a supercharger to the turbine. To achieve a supercharging effect on the turbine, mass air-flow is accelerated exponentially, in relation to the velocity of the air in question, at any given rate of change in time. The supercharging effect upon the turbine is due to the very high optimal pressures now achievable by the electric compressor, which can be tuned to the flight condition and altitude for which the electric compressor fan is designed.
The preferred embodiment of the invention further comprises a gas turbine engine in which the turbine rotors and the compressor rotors are not connected by a drive shaft. Rather, the turbine rotors are connected to a drive shaft which joins them and are in turn a series of ring generators (dependent on the number of turbine disks) that transforms the mechanical energy from the turbine to electrical energy for the multi-axial ringmotor compressor and fan. Thus, a compressor rotor, and a low-bypass turbofan as In a supersonic configuration is driven electrically, and not driven by the drive shaft from the turbine as in the current art; and the section of the engine that constitutes the compressor section is not connected by a drive shaft to the turbine section or the combustor section of the engine. The separation of the compressor section from the turbine and the drive shaft, and the ability to drive the compressor rotors electrically and independently (all rotor stages rotate at velocities configured to maximize energy conservation and provide rise to enthalpy states of mass flow between compressor stages), these are unique elements of the invention.
With each fan blade compressor section being independent of the other, compressor stages may be optimized aerodynamically, and compressed air ratios, fractional and mass air flow flows can be optimized to each flight condition (idle, acceleration, afterburner, cruise, deceleration), maximizing the efficiencies of the compressor. In such circumstances, the electric compressor turbine engine functions as a mass-flow dynamic device, separate from the diffuser stages, combustor and turbine. The electric compressor is ultimately used as a throttling and engine cycle mechanism, and its velocity is independent of the turbine engine, but contributes largely to achieving required compressor ratios for combustion, mass air flow, by-pass air for thrust, and optimal fuel burn. This permits high compression ratios and finely tuned air pressures, engine cycle efficiencies independent of combustion, consistent fuel burn, effective temperature operation and cooling. Higher energy levels are achievable, and broader flight envelopes are possible because the compressor stage acts independently.
1) Resultant polytropic efficiencies of the compressor and turbine are at 95 percent or better. In the case of a multiaxial electric compressor using distinct ringmotor stages for each rotor stage, tangential velocity may be increased from one rotor stage to the next, moving downstream with the flow, hence work is added to the flow unlike multiaxial mechanically driven compressor designs whereby work is maintained, and in current art of most designs, work flow done by the fluid is lost.
A further advantage of the electrically driven compressor is that rotational speed of the rotor stages does not suffer from spool up or spool down time (the time spent increasing or decreasing the rotational speed of the drive shaft) as is the case in traditional turbine designs, and the speed of the compressor rotors can be more quickly adjusted to achieve optimum performance of the engine based on different flight conditions, airframe loads, and optimal combustion performance.
The invention demonstrates that a multi-disc, turbofan assembly of the invention concept, because each fan disc is driven independently by an electric ring motor, the fan pressure ratio (hence the mass flow ratio) and the bypass ratio can be varied and optimized against temperature across the main components, fan, compressor and turbine.
   Mathematical Basis for Electrical Compressor and Fan, Power and Efficiency Optimization: Advantage over Current State-of-the-Art

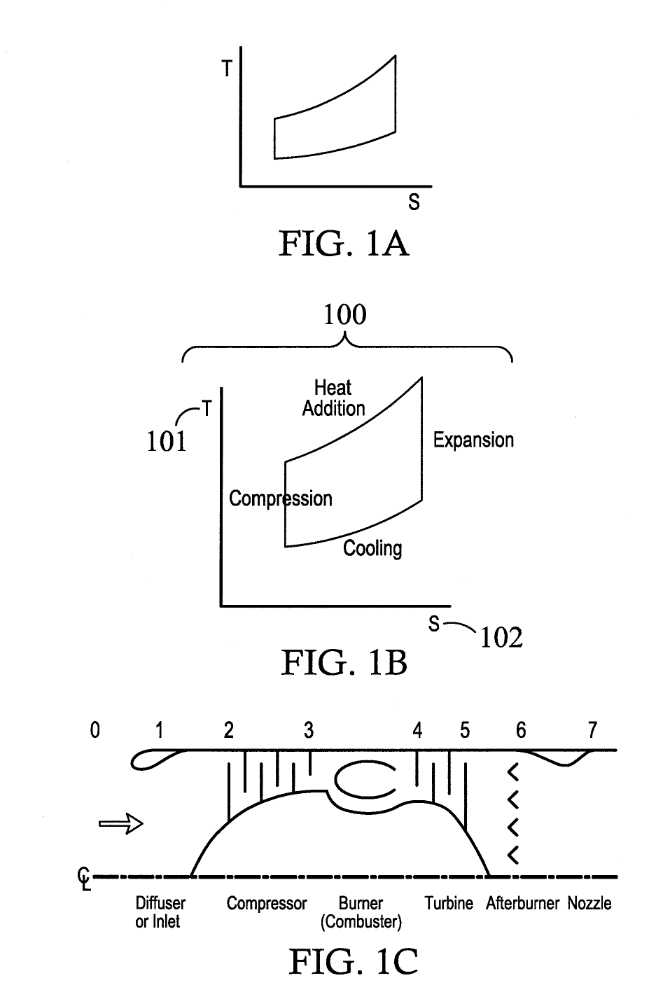

In thermodynamics a gas turbine engine is presented using the Brayton cycle 100, as shown in FIG. 1.0a, with derived expressions for efficiency and work as functions of the temperature 101 at various points in the cycle 102. What is performed is an “ideal cycle analysis”, a method of expressing the thrust and thermal efficiency of a segment of a turbine, namely the compressor and the fan, of which is the discussion for an “electric compressor” and “fan”, and the useful design variables for a predictive performance analysis and the advantages numerically described, in support of previously discussed advantage claims of an electric compressor and fan as compared to current art in the field. The ideal cycle analysis is extended to take account of various inefficiencies in the different components of a proposed electrical compressor and fan configuration using powered ring motors and in this case becomes a non-ideal cycle analysis.

### Objective of Ideal Cycle Analysis

Mathematical expressions will allow the definition of a particular performance and then determine the optimum component characteristics for a compressor meeting specific flight conditions at a given mission. The ideal cycle analysis addresses only the thermodynamics of airflow within the compressor and fan. It does not describe the details of the components and the intricate aerodynamics and efficiencies that occur during operation. Results of the various components are in the form of mathematical equations defining performance (e.g. pressure ratios, temperature ratios, entropic equations)

### Notation and Station Numbering:

FIG. 1.0b is a depiction of gas turbine engine station numbering with compressor defined. The Brayton cycle depicted in FIG. 1.0a is included.

A. Mathematical Notation for an Electric Multistage Ringmotor Compressor and Fan:

$${T}_{T} - T ( 1 + \frac{γ - 1}{2} {M}^{2} ) , \text{?} - {P ( 1 + \frac{γ - 1}{2} {M}^{2} )}^{\frac{Y}{γ - 1}}$$

$$\frac{{T}_{{T}_{0}}}{{T}_{0}} ≡ {θ}_{0}$$

$$\frac{\text{?}}{{T}_{0}} ≡ \text{?}$$

$$\frac{{P}_{{T}_{0}}}{{P}_{0}} = {δ}_{U} \\ ( {δ}_{0} = {θ}_{0} γ / γ - 1 )$$

$$\text{?} \text{indicates text missing or illegible when filed}$$

Stagnation properties, T_{T} & P_{T}, are more easily measured quantities than static properties (T and p). Thus, it is standard convention to express the performance of various components in terms of stagnation pressure and temperature ratios:
p° total or stagnation pressure ratio across compressor and fan (d, c, f, s, a, n)
t° total or stagnation temperature ratio across compressor and fan (d, c, f, s, a, n)
   where d=diffuser (or inlet), c=compressor, and f=fan.

For an electrical ring motor compressor and fan ideal assumptions are proposed:
1) Inlet/Diffuser p_{d}=1, t_{d}=1 (adiabatic, isentropic)
2) Compressor: t_{c}=p_{c}^{g-1/g}, t_{f}=p_{f}^{g-1/g}
3) Fan: t_{f} =p_{f}^{g-1/g}
4) Stator: sₛ=1, sₛ=1

B. Ideal Cycle Analysis Example: Turbojet Engine:

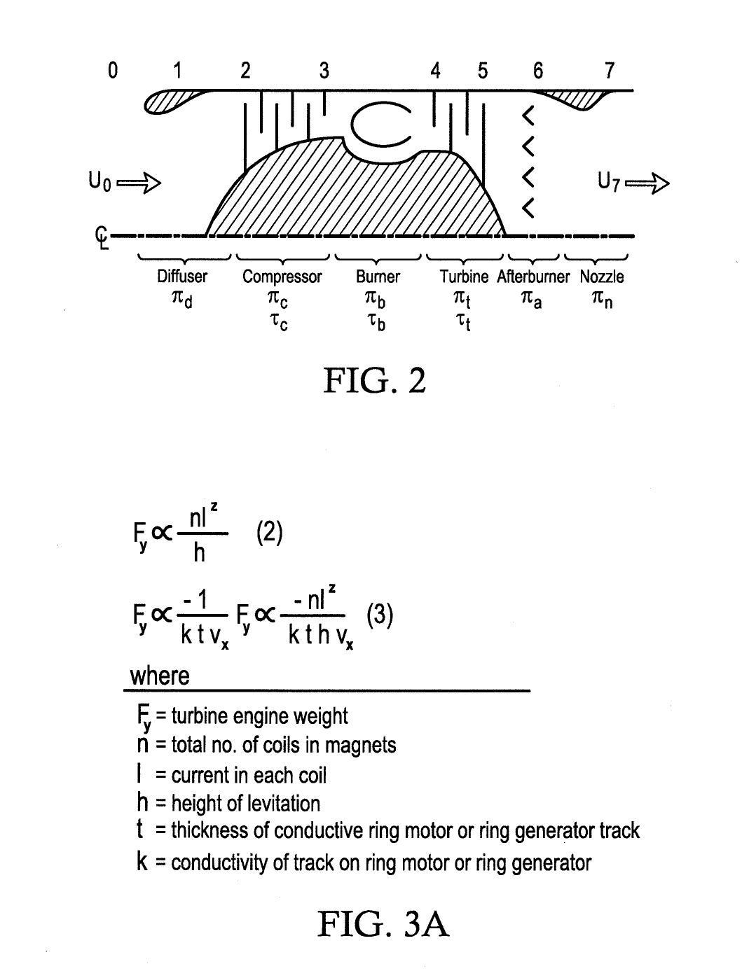

FIG. 2.0a l depicts a schematic with appropriate component notations, compressor defined.

Methodology:

Determine thrust by finding uₑₓᵢₜ/uₒ in terms of qₒ so as to create a power balance defining the relation of turbine parameters to compressor parameters, and therefore an energy balance across the compressor, relating the compressor temperature rise to the fuel flow rate and fuel energy usage and content in the combustor. The goal is to exhibit a larger compressor temperature rise through conservation of energy mass flow and reduction of aerodynamic losses due to increased thermal efficiency by fuel consumption reduction with a shaftless electric compressor concept.

The expressions for thrust and I of a turbojet are provided:

T=\dot{m}┌(1+f)u [symbol] −uₙ┐+(p [symbol] −pₙ)A

[symbol]

where f is the fuel/air mass flow ratio

$$T = \dot{m} [ \text{?} - {u}_{0} ] ⇒ \frac{T}{\dot{m} {a}_{0}} = {M}_{0} ⌊ \frac{\text{?}}{{u}_{0}} - 1 ⌋$$

$$( neglecting the fuel )$$

$$I = \frac{F}{{\dot{m}}_{f} g} = \frac{F}{g \dot{m} f}$$

$$\text{?} \text{indicates text missing or illegible when filed}$$

With algebra manipulation of these expressions into more useful forms an expression for the exit velocity is written for the compressor (this does not account for aerodynamic drag reduction and benefit due to magnetically levitated induction air bearings in the electric ring motor compressor stage(s) nor eddy current reduction at the interface of integral distal blade and ring interfaces):

$$\frac{\text{?}}{{u}_{0}} = \frac{\text{?}}{{M}_{0}} \sqrt{\frac{γ R \text{?}}{γ {RT}_{0}}} ≅ \frac{\text{?}}{{M}_{0}} \sqrt{\frac{\text{?}}{{T}_{0}}}$$

$$\text{?} \text{indicates text missing or illegible when filed}$$

and noting that:

$$\frac{\text{?}}{\text{?}} = T ( 1 + \frac{γ - 1}{2} \text{?} )$$

$$\text{?} \text{indicates text missing or illegible when filed}$$

Thus with further algebraic manipulation:

T_{T} [symbol] =T₀θ₀τ_{c}τ₀τₜ (**)

This expresses the exit temperature at the last stage of a multistage compressor as a function of the inlet temperature, the Mach number, and the temperature changes across each compressor component stage. This expression will be used again later and thus marked with a double asterisk (**).

The pressure at the exit of the compressor is written in a similar manner:

$$\text{?} = {{P}_{0} ( 1 + \frac{γ - 1}{2} {M}_{0}^{2} )}^{\frac{γ}{γ - 1}} {π}_{d} {π}_{c} {π}_{b} {π}_{t} {π}_{n}$$

$$\text{?} = {p}_{0} {δ}_{c} {π}_{c} {π}_{t} = \text{?} {( 1 + \frac{γ - 1}{2} \text{?} )}^{\frac{γ}{γ - 1}}$$

$${( 1 + \frac{γ - 1}{2} \text{?} )}^{\frac{γ}{γ - 1}} = {δ}_{0} {π}_{c} {π}_{t}$$

$$\text{?} \text{indicates text missing or illegible when filed}$$

Equate this to the expression for the temperature (**)

$$1 + \frac{γ - 1}{2} \text{?} = \text{?} \text{?} \text{?}$$

$$\text{?} \text{indicates text missing or illegible when filed}$$

Label it (***) to be used later in developing the following expression:

$$\text{?} = \sqrt{\frac{2}{γ - 1}} {{( {θ}_{0} {τ}_{c} {τ}_{t} - 1 )}^{1 / 2} }_{(* **)}$$

$$\text{?} \text{indicates text missing or illegible when filed}$$

Continue on the path to the expression for u₇/uₒ or uₑₓᵢₜ/uₒ

$$\frac{\text{?}}{{T}_{0}} = \frac{\text{?}}{\text{?}} \frac{\text{?}}{{T}_{0}} = \frac{{θ}_{0} {τ}_{c} {τ}_{b} {τ}_{t}}{{θ}_{0} {τ}_{c} {τ}_{t}} = {τ}_{b}$$

$$\frac{\text{?}}{{u}_{0}} = \frac{\text{?}}{{M}_{0}} \sqrt{\frac{\text{?}}{{T}_{0}}} = \frac{\sqrt{\frac{2}{γ - 1}}}{{M}_{0}} {( {θ}_{0} \text{?} {τ}_{t} - 1 )}^{1 / 2} \sqrt{{τ}_{b}}$$

$${θ}_{0} = 1 + \frac{γ - 1}{2} {M}_{0}^{2} ⇒ {M}_{0}^{2} = \frac{2}{γ - 1} ( {θ}_{0} - 1 )$$

$$Therefore \text{:}$$

$$\frac{\text{?}}{{u}_{0}} = \sqrt{\frac{( {θ}_{0} {τ}_{c} {τ}_{t} - 1 ) {τ}_{b}}{{θ}_{0} - 1}}$$

$$\text{?} \text{indicates text missing or illegible when filed}$$

Next t_{c}, compression is written in terms of tₜ, temperature by noting that they are related by the condition that the power used by the compressor is equal to the power extracted by the turbine. This assumes an adiabatic condition of enthalpy of mass flow, temperature, and velocity across the combustor (between the compressor/fan and the turbine) and electromagnetic power consumption for the compressor ring motor drive and levitation coils is equated to with power production (including losses and power conditioning) from either turbine ring generators or MHD drive using alkaline seeded exhaust in the electric compressor concept. The burner temperature ratio is expressed in terms of the exit temperature of the burner, (T_{T4} or more specifically qₜ=T_{T4}/Tₒ) as this is the hottest point in the engine, and is a frequent benchmark used for judging various designs.

The steady flow energy equation demonstrates that:

\dot{m}Δh_{T}=\dot{q}−\dot{w},

Assuming that the compressor and turbine are adiabatic, then: \dot{m}Δh_{T}=−rate of power density energy generation work done by the system=rate of power density energy consumption done on the system Since the turbine generator is connected through a magnetic flux of density “D” and an electromagnetic magnitude confined circumferentially to the turbine machine casing surrounding the compbustor, between the electric compressor/fan and turbine generator

\dot{m}Cₚ(T_{T}_{₃}−T_{T}_{₂})=\dot{m}Cₚ(T_{T}_{₄}−T_{T}_{₅})

assuming \dot{m} and Cₚ are the same.

This can be rewritten as:

$$( \frac{\text{?}}{\text{?}} - 1 ) \frac{\text{?}}{{T}_{0}} = ( \frac{\text{?}}{{T}_{0}} ) ( 1 - \frac{\text{?}}{\text{?}} )$$

$$where$$

$$\frac{\text{?}}{{T}_{0}} = \text{?} {θ}_{0} = {θ}_{0}$$

$$so \\ ( {τ}_{c} - 1 ) {θ}_{0} = {θ}_{t} ( 1 - {τ}_{t} )$$

$$or$$

$${τ}_{t} = 1 - \frac{{θ}_{0}}{\text{?}} ( {τ}_{c} - 1 )$$

$$\text{?} \text{indicates text missing or illegible when filed}$$

This is the first step relating the temperature rise across the turbine to that across the compressor with electromagnetics constant (equated to mechanical systems, not accounting for energy efficiency gains due to aerodynamic drag reduction and friction reduction for example, from magnetically levitated bearings).

Temperature Rise Across the Combustor with Change in Compression

The following step denotes the writing of an equation which represents the temperature rise across the combustor in ratio with the change in compression/change in temperature and in terms of qₜ=T_{T4}/Tₒ. The equation represents the ideal where by in compression Delta T is minimized, and this is most accomplished with a multistage, electric ringmotor compressor, where conservation of energy is maximized, enthalpy decay is minimized by the two largest variables against degrading performance; aerodynamic drag and mechanical friction. Magnetic air bearings (Maglev) address this, and it is unique to this invention. The equation follows:

$${τ}_{0} = \frac{{θ}_{t}}{{θ}_{0} {τ}_{c}}$$

and for an engine with an afterburner

$$\text{?} = \frac{\text{?}}{{0}_{t} \text{?}}$$

$$where \text{:}$$

$$τ = temperature ratio across compressor$$

$${0}_{t} - \frac{stagnation temperature at turbine inlet}{atmospheric temperature}$$

$${θ}_{c} = \frac{atmospheric stagnation temperature}{atmospheric static temperature}$$

$${a}_{c} = speed of sound$$

$$T = thrust$$

$$\text{?} \text{indicates text missing or illegible when filed}$$

Now substituting the expressions for t_{b}, and tₜ into an expression for u₇/u₀, and then into the first expression that was first written for thrust, results produce:

$$\frac{T}{\dot{m} {a}_{0}} = {M}_{0} [ {\{ ( \frac{{θ}_{0}}{{θ}_{0} - 1} ) ( \frac{{θ}_{t}}{{θ}_{0} {τ}_{c}} - 1 ) ( {τ}_{c} - 1 ) + \frac{{θ}_{t}}{{θ}_{0} {τ}_{c}} \}}^{1 / 2} - 1 ]$$

Specific Thrust for a Turbojet

This provides an expression for thrust in terms of design parameters for compression, combustion, Mach number, temperature and ultimately an optimized flight condition:

$$\frac{T}{\dot{m} {a}_{0}} = fnc . ( {M}_{0} , {τ}_{c} , \text{?} )$$

$$\text{?} \text{indicates text missing or illegible when filed}$$

With algebra

$$[ add \& substract \frac{2 θ}{γ - 1} ( \frac{\text{?}}{{θ}_{0} \text{?}} ) ]$$

$$\text{?} \text{indicates text missing or illegible when filed}$$

Another form of this equation is:

$$\frac{T}{\dot{m} {a}_{0}} = \sqrt{\frac{2 {θ}_{0}}{γ - 1} ( \frac{\text{?}}{{θ}_{0} \text{?}} - 1 ) ( \text{?} - 1 ) + \frac{\text{?} {M}_{0}^{2}}{{θ}_{0} \text{?}}} - {M}_{0}$$

$$\text{?} \text{indicates text missing or illegible when filed}$$

The next step involves re-writing the equation for specific impulse, enthalpy rise, Mach number and fuel flow/heating value ratio in terms of these same parameters. This is done by beginning with writing the First Law across the combustor to relate the fuel flow rate and heating value of the fuel to the total enthalpy rise.

$$\text{?} h = \dot{m} {C}_{p} ( {T}_{{T}_{4}} - \text{?} )$$

$$and$$

$$f = \frac{{\dot{m}}_{f}}{\text{?}} = \frac{{C}_{p} {T}_{0}}{h} ( \text{?} - \text{?} {θ}_{0} )$$

$$\text{?} \text{indicates text missing or illegible when filed}$$

where again, f is the fuel/air mass flow ratio

The specific impulse thus becomes:

$$I = \frac{T}{gf \dot{m}} = \frac{{a}_{0} h ( \frac{T}{\dot{m} {a}_{0}} )}{{gC}_{p} {T}_{0} ( \text{?} - \text{?} {θ}_{0} )}$$

$$\text{?} \text{indicates text missing or illegible when filed}$$

Specific Impulse for an ideal turbojet where I is expressed in terms of the design parameters of Mach number, mass flow, compression, temperature, change in enthalpy rise, fuel flow/heating value ratio and physical constants, as depiced in FIG. 4.

Similarly, the overall efficiency, hₒᵥₑᵣₐₗₗ is

$${η}_{overall} = \frac{{Tu}_{0}}{{\dot{m}}_{f} h}$$

$${η}_{overall} = \frac{{a}_{0}^{2} {M}_{0} ( \frac{T}{\dot{m} {a}_{0}} )}{{C}_{p} {T}_{0} ( \text{?} - \text{?} {θ}_{0} )}$$

$$or$$

$${η}_{overall} = \frac{{M}_{0} ( γ - 1 ) ( \frac{T}{\dot{m} {a}_{0}} )}{( \text{?} - \text{?} {θ}_{0} )}$$

$$\text{?} \text{indicates text missing or illegible when filed}$$

The ideal thermal efficiency is:

$${η}_{thermal} = 1 - \frac{1}{{θ}_{0} \text{?}}$$

$$\text{?} \text{indicates text missing or illegible when filed}$$

and the propulsive efficiency can be found from hₚᵣₒₚ=hₒᵥₑᵣₐₗₗ/hₜₕₑᵣₘₐₜ

Magnetic Drag

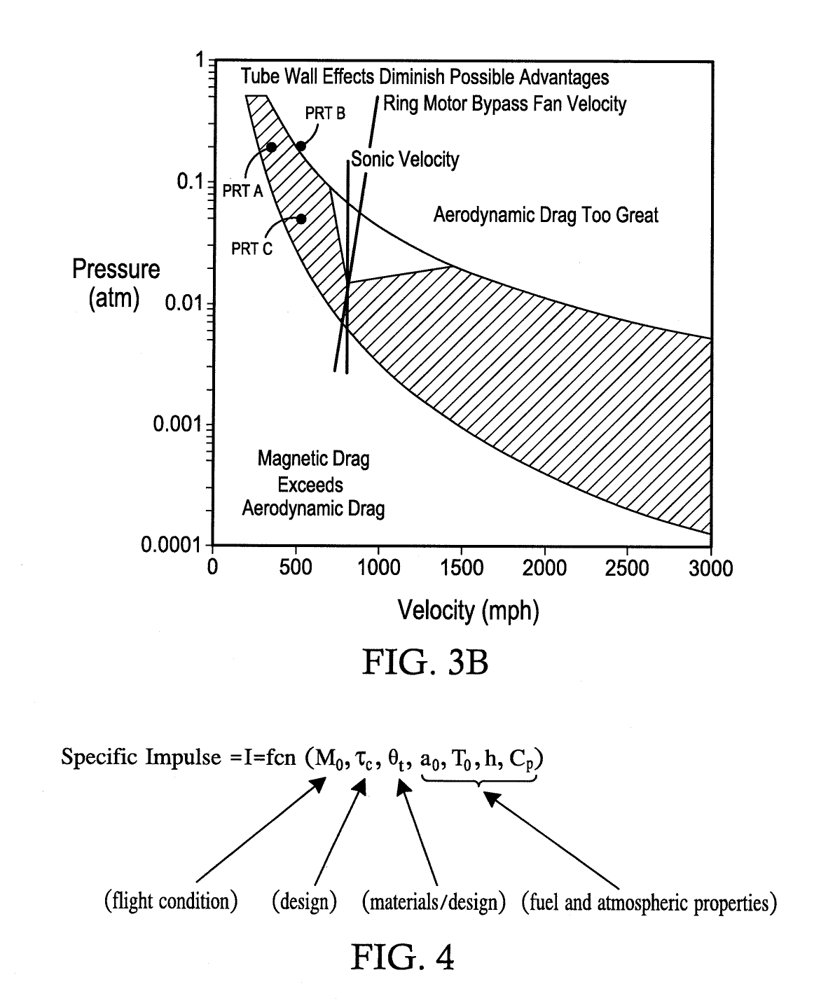

For electrodynamic suspension, magnetic drag losses are proportional to the weight of the induction ringmotor machine and are inversely proportional to travel velocity. The generally accepted form of the drag equation is given by equations 2 and 3 of 3.0b for high velocities. Here Fy is the ringmotor weight, or vehicle weight in the case of a tracked Maglev vehicle, n is the total number of coils in magnets, I is the current in each coil, h is the height of levitation, t is the thickness of the conductive track, and s is the conductivity of the track. This is depicted in FIG. 3.

For a single stage tracked, magnetically levitated ringmotor compressor stage of mass 1040 lbs., polytropic efficiency of 0.90, 5000 SHP with mass flow rate of 24 lbs./sec. (assumes a five stage multiaxial compressor design, the magnetic drag energy consumption is estimated at 1.043 MW while the aerodynamic drag energy consumption is estimated at 5.4 MW operating at 0.2 atm (20 kPa). Aerodynamic drag dominates the energy consumption for electric compressor ringmotor concepts, however close gap tolerance to maintain high energy density from high shear pressure gap performance (16.0-20.5 lbs./sq. in.) offsets the losses of magnetic and aerodynamic drag bringing them close to match (not as seen in mechanically driven designs), and overall efficiencies are higher than in current art of multiaxial mechanically driven compressors. Lower weight and no mechanical drag from drive shafts adds further advantage and offsets magnetic drag which in overall design offers the potential of lot lower horse power to drag ratios. Further, higher mass flow rates may be tolerated, along with higher stage loading due to rim driven high torque design, consequently higher stage pressures are achievable.

Lastly, compressor area, and subsequent stage diameter design optimization is critical In defining further performance advantages as magnetic drag reduces with diameter and raise in shear pressure to achieve high energy level densities. Analysis such as this can be used to define feasible pressure versus velocity profiles such as that shaded in FIG. 3B. This graphic relates to research on power magnetics of PRT Maglev vehicles using Halbach Array tracks for levitation and propulsion. Larger vehicles, lower magnetic drags, and different vehicle-tube clearances would change the window of opportunity.

Energy Exchange with Moving Blades (Compressor)

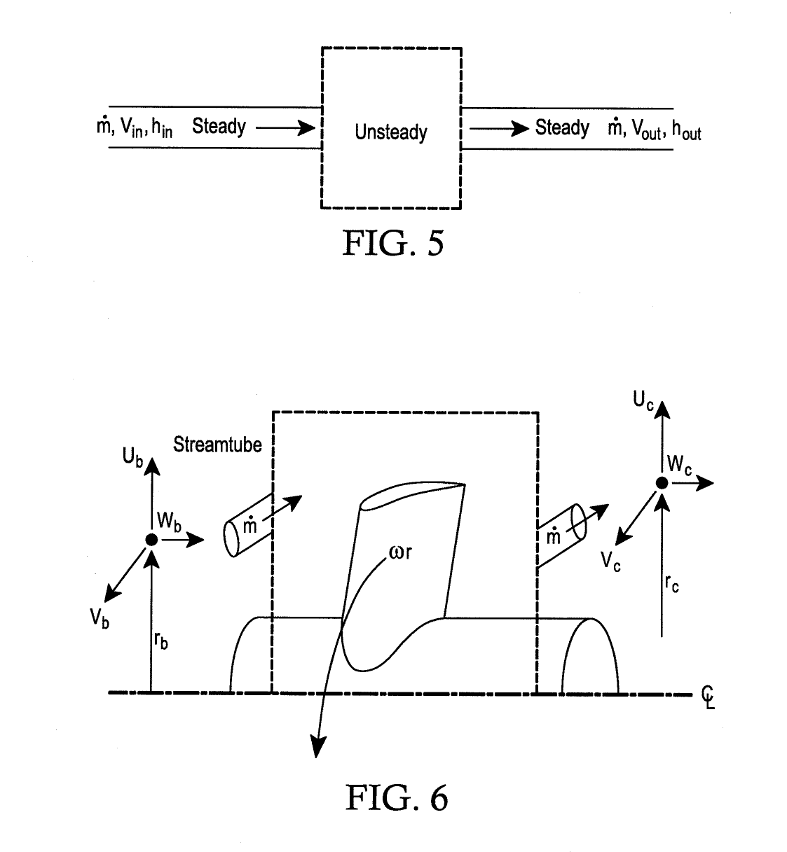

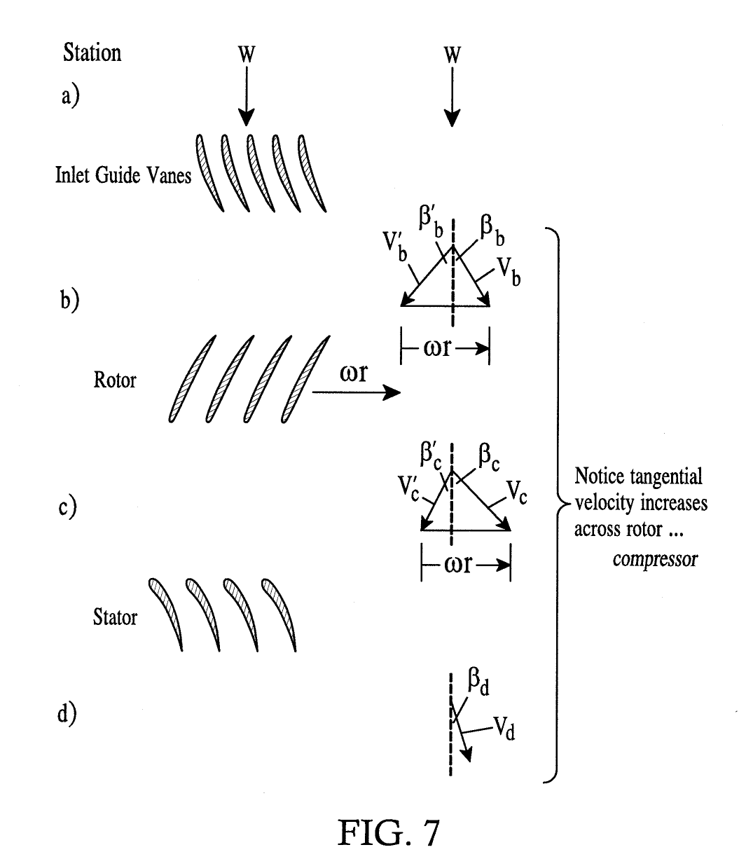

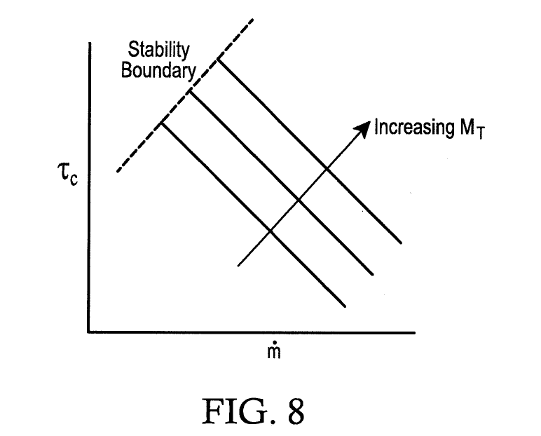

So far we have only looked at the thermodynamic results of compressors and turbines (p's and t's). Here we will look in more detail at how the components of a gas turbine compressor produces the thermodynamic results in terms of pressure and temperature, and compare thermodynamic mathematical expressions with current art, as compared with the new art of the invention. In a compression machine it is only possible to change the total enthalpy of the fluid with an unsteady process (e.g. moving blades). The amount of energy required to instill an enthalpy change, Delta E, must be analyzed with steady flow equations and design tools at this preliminary level as are known in thermodynamics and propulsion dynamics and considering improvements in the power equation of the comoporession machine in question via evaluation of steady flow in and out of a component compressor as shown in FIG. 5.

### The Euler Turbomachinary Equation and Multiaxial Compressors

The Euler turbine equation relates the power added to or removed from the flow, to characteristics of a rotating blade row. The equation is based on the concepts of conservation of angular momentum and conservation of energy. A representative model of the blade row describing representative vectors and metrics:

Applying conservation of angular momentum, we note that the torque, T, must be equal to the time rate of change of angular momentum in a streamtube (blade row representative of a rotor stage of the compressor) that flows through the device

T=\dot{m}(v_{c}r_{c} y_{b}r_{b})

This is true whether the blade row is rotating or not. Sign matters (i.e. angular momentum is a vector—positive means it is spinning in one direction, negative means it is spinning in the other direction). Dependent on definition and design, there can be positive and negative torques, and positive and negative angular momentum. In FIG. 1.30, torque is positive when V_{tangential out}>V_{tangential in}—the same sense as the angular velocity. If the blade row is moving, then work is done on/by the fluid. The work per unit time, or power, P, is the torque multiplied by the angular velocity, w

P=Tω=ω\dot{m}(v_{c}r_{c}−v_{b}r_{c})

If torque and angular velocity are of like sign, work Is being done on the fluid (a compressor). If torque and angular velocity are of opposite sign work is being extracted from the fluid (a turbine). Here is another approach to the same idea:

If the tangential velocity increases across a blade row (where positive tangential velocity is defined in the same direction as the rotor motion) then work is added to the flow (a compressor).

If the tangential velocity decreases across a blade row (where positive tangential velocity is defined in the same direction as the rotor motion) then work is removed from the flow (a turbine).

From the steady flow energy equation:

\dot{q}−\dot{w}ₛ=\dot{m}Δhₜ with

\dot{q}=0 and −\dot{w} [symbol] =P

P=m|h_{T}_{_{c}}−h_{T}_{₆}}

Then equating this expression of conservation of energy with our expression from conservation of angular momentum, we arrive at:

h_{T}_{_{c}}−h_{R}_{_{b}}=ω(r_{c}v_{c}−r_{b}v_{b})

or for a perfect gas with Cₚ=constant

Cₚ( [symbol] −T_{T}_{_{b}})=ω(r_{c}v_{c}−r_{b}v_{b})

The Euler Turbomachinary Equation relates the temperature ratio (and hence the pressure ratio) across a compressor to the rotational speed and the change in momentum per unit mass. The velocities used in this equation are what are denoted as absolute frame velocities (as opposed to relative frame velocities).

When angular momentum increases across a blade row, then T_{Tc}>T_{Tb} and work was done on the fluid (a compressor).

When angular momentum decreases across a blade row, then T_{Tc}<T_{Tb} and work was done by the fluid (a turbine).

An axial compressor is typically made up of many alternating rows of rotating and stationary blades called rotors and stators, respectively, as shown. The first stationary row (which comes in front of the rotor) is typically called the inlet guide vanes or IGV. Each successive rotor-stator pair is called a compressor stage. Hence compressors with many blade rows are termed multistage compressors.

One way to understand the workings of a compressor is to consider energy exchanges. An approximate picture of this is done using the Bernoulli Equation, where P_{T} is the stagnation pressure, a measure of the total energy carried in the flow, p is the static pressure, a measure of the internal energy, and the velocity terms are a measure of the kinetic energy associated with each component of velocity (u is radial, v is tangential, w is axial).

$${P}_{T} = p + \frac{1}{2} ρ ( {u}^{2} + {v}^{2} + {w}^{2} )$$

The rotor adds swirl to the flow, thus increasing the total energy carried in the flow by increasing the angular momentum (adding to the kinetic energy associated with the tangential or swirl velocity, ½rv²).

The stator removes swirl from the flow, but it is not a moving blade row and thus cannot add any net energy to the flow. In the invention, the electric multiaxial compressor concept, every stator row is a slower moving airfoil blade row, thus having the capacity to add net energy to the flow, as well as acting as a conversion device to the flow, adding some kinetic energy to the flow and raising the static pressure simultaneously of the flow. Typical velocity and pressure profiles through a multistage axial compressor look like those shown in FIG. 1.43. A typical velocity and pressure profiles through an electric multistage ringmotor axial compressor are exhibited in FIG. 1.44 where pressure rise is greater and velocity drop and Mach number are reduced across the compressor.

Note that the IGV also adds no energy to the flow. It is designed to add swirl in the direction of rotor motion to lower the Mach number of the flow relative to the rotor blades, and thus improve the aerodynamic performance of the rotor.

Velocity Triangles for an Axial Compressor Stage

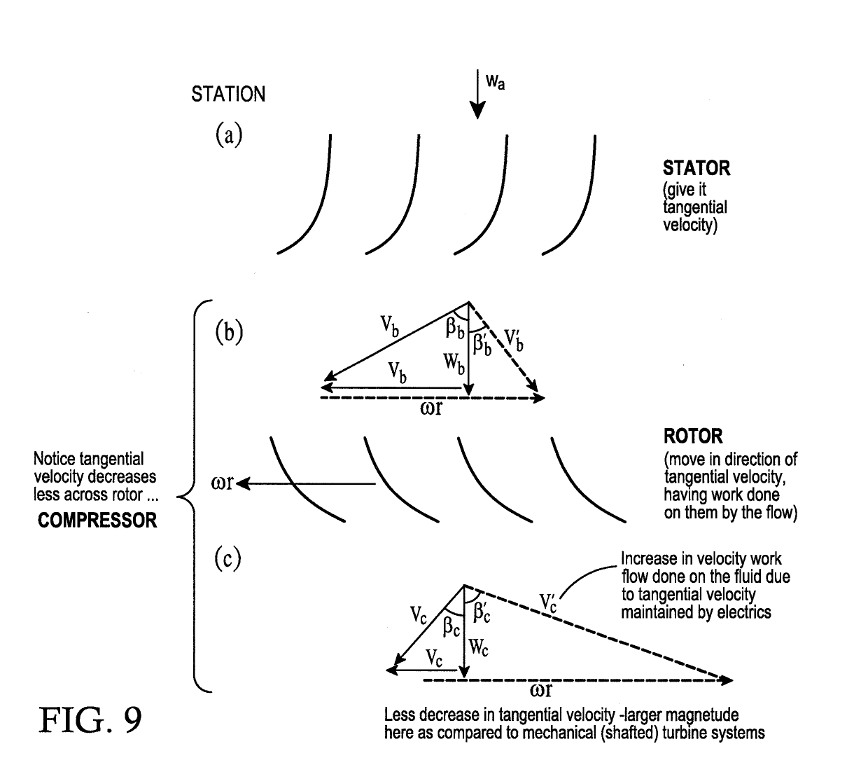

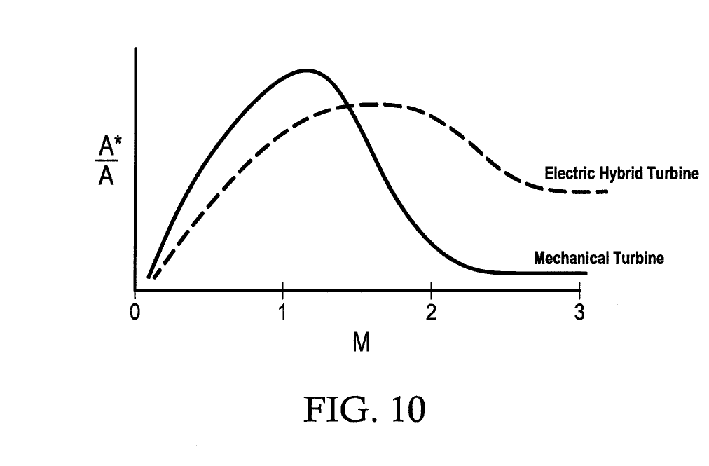

Velocity triangles are typically used to relate the flow properties and blade design parameters in the relative frame (rotating with the moving blades), to the properties in the stationary or absolute frame. We begin by “unwrapping” the compressor. That is, we take a cutting plane at a particular radius and unwrap it azimuthally to arrive at the diagrams shown in FIG. 9.6. Here we have assumed that the area of the annulus through which the flow passes is nearly constant and the density changes are small so that the axial velocity is approximately constant. Velocity triangles for an axial compressor stage. Primed quantities are in the relative frame, unprimed quantities are in the absolute frame.

In drawing these velocity diagrams it is important to note that the flow typically leaves the trailing edges of the blades at approximately the trailing edge angle in the coordinate frame attached to the blade (Le. relative frame for the rotor, absolute frame for the stator). We will now write the Euler Turbomachinary Equation in terms of stage rotor design parameters: w, the rotational speed, and b_{b} and b_{c}′ the leaving angles of the blades.

Cₚ( [symbol] − [symbol] )=ω(r_{c}v_{c}−r_{b}v_{b})

From geometry,

v_{b}=w_{b} tan b_{b} and v_{c}=w_{c} tan b_{c}=wT_{c}w_{c} tan β′_{c}

so

Cₚ( [symbol] − [symbol] )=ω(ωr_{c}²−r_{c}w_{c} tan β′_{c}−r_{b}w_{b} tan β_{b})

or

So we see that the total or stagnation temperature rise across the stage increases with the tip Mach number squared, and for fixed positive blade angles, decreases with increasing mass flow. This behavior is represented schematically.

Velocity Traiangles for an Axial Flow Mechanical Compressor Stage and an Axial Flow Electrical Compressor Stage

We can apply the same analysis techniques to a turbine. Again, the stator does no work. It adds swirl to the flow, converting internal energy into kinetic energy. The turbine rotor then extracts work from the flow by removing the kinetic energy associated with the swirl velocity.

The appropriate velocity triangles are shown in FIG. 1.50, where again the axial velocity was assumed to be constant for purposes of illustration. As we did for the compressor, we can write the Euler Turbomachinary Equation in terms of useful design variables:

$$1 - \frac{\text{?}}{\text{?}} = \frac{{( ω r )}^{2}}{{C}_{p} \text{?}} [ \frac{{w}_{b}}{ω r} tan {β}_{b} + ( \frac{\text{?}}{ω r} tan \text{?} - 1 ) ]$$

$$\text{?} \text{indicates text missing or illegible when filed}$$

### The Turbo Ringmotor Bypass Fan

The propulsive efficiency of a simple turbojet can be improved by extracting a portion of the energy from an engine's gas generator to drive a ducted propeller, called a fan. The ducted propeller pushes a portion of the overall air through the turbine, but by-passes the turbine, exhausting to the rear at ambient air conditions. The fart increases the propellant mass flow rate with an accompanying decrease in the required propellant exit velocity for a given thrust. Since the rate of production of “wasted” kinetic energy in the exit propellant gases varies as the first power with mass flow rate and as the square of the exit velocity, the net effect of increasing mass flow rate and decreasing the exit velocity is to reduce the wasted kinetic energy production and to improve the propulsive efficiency.

Subsequently modern turbine design has incorporated a marginalized design approach to incorporating turbofans into baseline turbojet turbomachinary to what is termed the “hot section” of the turbine. To achieve high Mach numbers for supersonic flight, with good propulsive efficiency via reduced kinetic energy losses, turbomachinary design has moved to supersonic low-bypass jet engine designs, whereby the bypass fan is reduced in size compared to a pure turbofan to maintain a relatively high mass air flow and exhaust velocity Mach number. The approach offers greater efficiency through moderation of typically high endothermic and entropic thermal reactions of pure turbojets by optimizing mass flow rates and exhaust velocities.

The use of a turbofan stage(s) enables the turbine to be refined to the cruise flight condition and low-speed flight conditions by utilizing more of the combustion gases efficiently and by reducing the wasted kinetic energy. Improvements can be observed in a ring motor turbofan where it is not constrained by the available rotating speeds in a multi-shaft turbine design as it is rim driven and enables the fan stage to optimize and maximize typically constrained design variables as follows: optimized design in turbomachinary is focused on Ideal” mass flow through the engine core and the fan. In current turbofan designs, or supersonic low-bypass turbine designs the temperature drop through the turbine is greater than the temperature rise through the compressor since the turbine drives the fan in addition to the compressor.

In the invention, there is no drive shaft driving the fan subsequently the temperature drop across the fan can be minimized as compared to across the compressor, as this is beneficial in maintaining temperature during compression and assists in the entropic and endothermic reactions in the atomization of fuel in the combustor, subsequently mass flow of the fan can be increased relative to the compressor, more air can be compressed, Delta M over Delta C at any given T. However, without a drive shaft there remains a load on the turbine, in the form of a future design iteration for an electric generation source in the form of a turbine ring generator, which causes an electric load on the turbine machine invention. With electric filter conditioning, direct AC to AC power transmittal and superconducting power transmission (bringing electric resistance to zero), and the inner compressor or fan rotating ring, with an in-situ advanced composite thermal management barrier (aerogel), allows for coil induction heat to be contained internally in the compressor (the inner rotating ring) where it is needed, but offers cool operating conditions externally against the airframe (outer fixed ring). Delta T across the compressor is conserved (reduces temperature drop, assists in maintaining heating of air due to compression and ultimately hotter combustion temperature for fuel atomization).

Mass flow can be increased since stage loading for each compressor stage can be increased in an electric compressor as previously discussed (mass flow increases load capacity). A ring motor electric bypass fan in the SonicBlue configuration of superconducting electromagnetics and magnetically levitated compressor offers zero electric resistance and zero drag. This further adds to the ability of the invention to mass load the turbo fan with inlet air beyond current design levels, thus increasing over all mass flow in the engine.

Quasi-One-Dimensional Compressible Flow in an Area Duct from a Turbofan

$$p = rRT \qquad ( ideal gas )$$

$$\frac{p}{{p}_{c}} {( \frac{T}{{T}_{c}} )}^{\frac{γ}{γ - 1}} \qquad ( isentropic flow )$$

$$\frac{{T}_{c}}{T} = 1 + \frac{{u}^{2}}{2 {C}_{p} T} = 1 + \frac{γ - 1}{2} {M}^{2} \qquad ( energy equation )$$

This implies that:

$$\frac{\text{?}}{P} = {[ 1 + \frac{γ - 1}{2} {M}^{2} ]}^{\frac{γ}{γ - 1}}$$

$$\text{?} \text{indicates text missing or illegible when filed}$$

Then from conservation of mass equation:

$$\begin{matrix}ρ uA = \dot{m} & ( cons . of mass )\end{matrix}$$

$$\begin{matrix}\begin{matrix}P \\ RT\end{matrix} uA - \dot{m} & \frac{\text{?} M}{{\sqrt{{RT}_{c}} [ 1 + \frac{v - 1}{2} {M}^{2} ]}^{\frac{γ + 1}{2 ( γ - 1 )}}} A = \dot{m}\end{matrix}$$

$$\text{?} \text{indicates text missing or illegible when filed}$$

The above equation relates the flow area, the mass flow, the Mach number and the stagnation conditions. For fan design and analysis it is frequently rewritten in a non-dimensional form by dividing through by the value at M=1 (where the area at M=1 is A*):

$$\frac{A}{{A}^{*}} = {\frac{1}{M} [ \frac{2}{γ + 1} ( 1 + \frac{γ - 1}{2} {M}^{2} ) ]}^{\frac{γ + 1}{2 ( γ - 1 )}}$$

which takes a form something like that shown

A turbofan engine is presented with an electric turbofan upstream of a multiaxial electric compressor as previously described in this paper. Here the core flow and bypass flow are mixed together through an afterburner and nozzle. This is shown in Figure XXX, a general form of relationship between flow area and Mach number of a Turbofan (does not account for stagnation condition at the IGV of the compressor). The Ideal turbofan cycle with mechanical compressor and mixed stream with afterburner is shown in the T-s Diagram.

In the current art, modern fighter aircraft use this type of engine because it gives the high specific thrust with the afterburner on and lower thrust specific fuel consumption than a pure turbojet engine when the afterburner is off.

The analysis of this type of engine requires the definition of the total temperature and total pressure ratios across the mixer. The flow in the bypass duct from station 13 to 16 is considered to be reversible and adiabatic, The bypass stream enters the mixer at station 16 with the same total properties as the fan discharge. An energy balance of the mixer gives:

m6CpT16+m16CpTt16=m6aCpTt6A

Fluid dynamics requires equal static pressures at stations 6 and 16. Normal design of the mixer has the mach numbers of the two entering streams equal. In the case of an electric ringmotor turbofan, and electric multiaxial compressor, the Mach numbers of the two respective streams can be matched, thus reducing boundary layer drag at the mixer wall, unsteady enthalpic mixing currents mid-stream, and the two pressures of the entering streams can be made equal, thus converse to mechanically driven designs total pressure ratio of the mixer can be brought to unity creating an ideal low-bypass turbofan engine with fan and compressor driven electrically.

Compared to the core stream, the fan stream of the turbofan contains a fan rather than a compressor and does not have either a combustor or a turbine. In low-bypass supersonic mixer turbine designs the turbofan sits upstream of the compressor, its ambient temperature flow mixing downstream outside of the combustor and ahead of the afterburner. Current art in turbomachinary design of a mixed flow turbofan engine with afterburner as shown in Figure XXX using mechanical linkages (drive shaft) versus electrical load linkages as in the current invention prevent any management of gas mixing in the mixer area just described. Since velocity of bypass air and compressor air can be controlled electrically through RPM, the mixing process can be optimized. Further the management of the mixing process in this type of turbine proposed in the invention can have a positive effect on the combustion forming process adjacent to the mixer behind the turbine.

Turbofan Cycle Analysis: Mechanical vs. Electric

The power balance between the fan (Tf), compressor (Tc) and turbine (Tr) is developed through the relationship between the total temperature (Tt) ratios across these components in the following expression:

Tt=1−Tr/T^{A}[Tc−1+@9(Tf−1)]

For the given values of Tr, T^{A}, and Tc, there is one value of Tf for each value of @ (alpha) that satisfies all temperature ratios across these components. This can be further expressed in terms of bypass ratio, ©, such that

$$@ = \frac{{T}^{⋀} ( Tc - Tf )}{TrTc ( Tf - 1 )} \frac{Tc - 1}{Tf - 1}$$

An expression of this equation can be derived in integral form (change in temperature and pressure over time, to total change in bypass air and thus fan pressure ratio) to demonstrate a variable fan pressure ratio and bypass ratio for an electric turbofan as compared to a mechanically driven turbofan as it relates to temperature, as bypass ratio is inversely proportional to temperature and velocity.

The invention described herein demonstrates that a multi-disc, turbofan assembly concept, because each fan disc is driven independently by an electric ring motor, the fan pressure ratio (hence the mass flow) and the bypass ratio can be varied and optimized against temperature across the main components, fan, compressor and turbine. An integral expression of an “electric variable ratio bypass fan” with “bypass flow” in a mixed flow after burning turbofan, as it relates to pressure and temperature, is described as:

$$@ = \frac{\begin{matrix}\begin{matrix}Tc - Tf \\ {S}^{′} - P ( cP - fP ) * [ Tc - 1 + @ ( Tr - 1 ) ]\end{matrix} \\ Tr\end{matrix}}{\begin{matrix}\begin{matrix}Tc - Tr \\ {S}^{′} - P ( cP - Tr ) * [ Tf - 1 + @ ( Tf - 1 ) ]\end{matrix} \\ Tf\end{matrix}} .$$

In an electric bypass turbofan in an after burning mixed flow turbine, due to the variable speed fan (multi-ringmotor fan), for the integral formation FIG. 1.72 (as turbine temperature moves toward (Delta time) an optimal compressor-fan temperature ratio of 1.0 (single fan disc), divided by the fan temperature as it moves (Delta time) toward the compressor-turbine temperature ratio, the power balance of compressor and fan total temperature is removed from the total endothermic/enthalpic power balance of the turbine, remaining with the bypass thermic reaction of mixer gases and variation of pressure across the fan (fan pressure ratio of change In Delta P). The expression accounts for variation in temperature and pressure at predicted variation of flow volume (bypass volume) integrated over time across all components (fan, compressor, turbine.

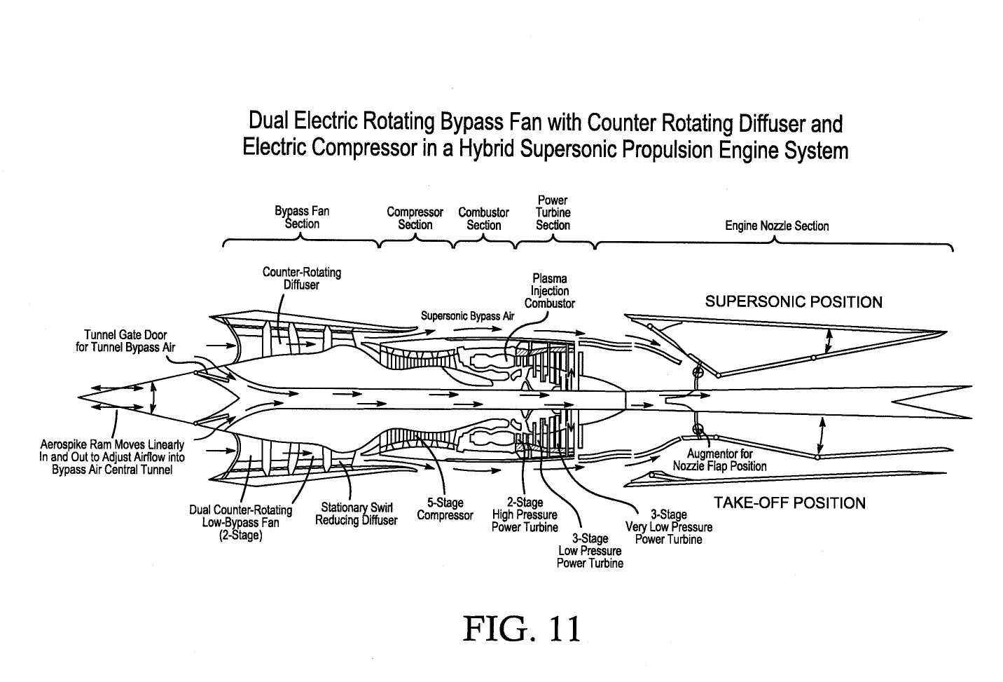

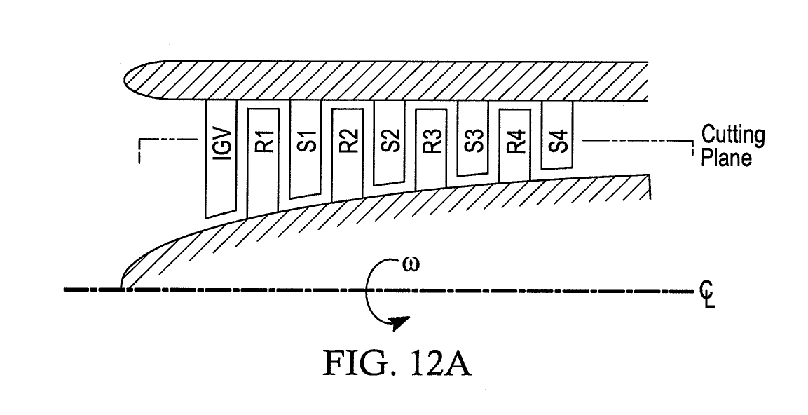

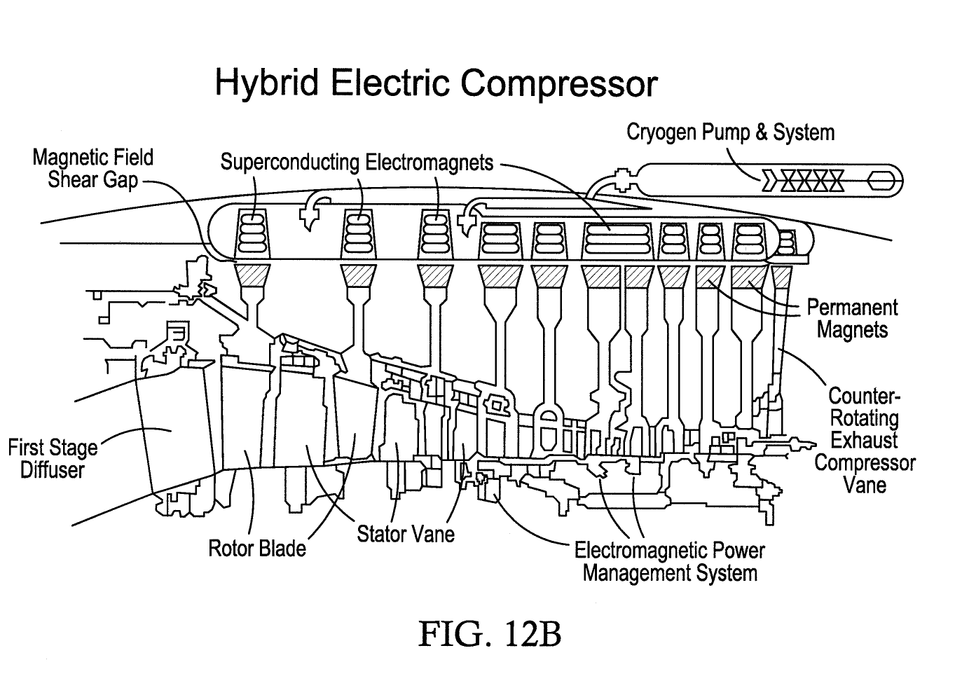

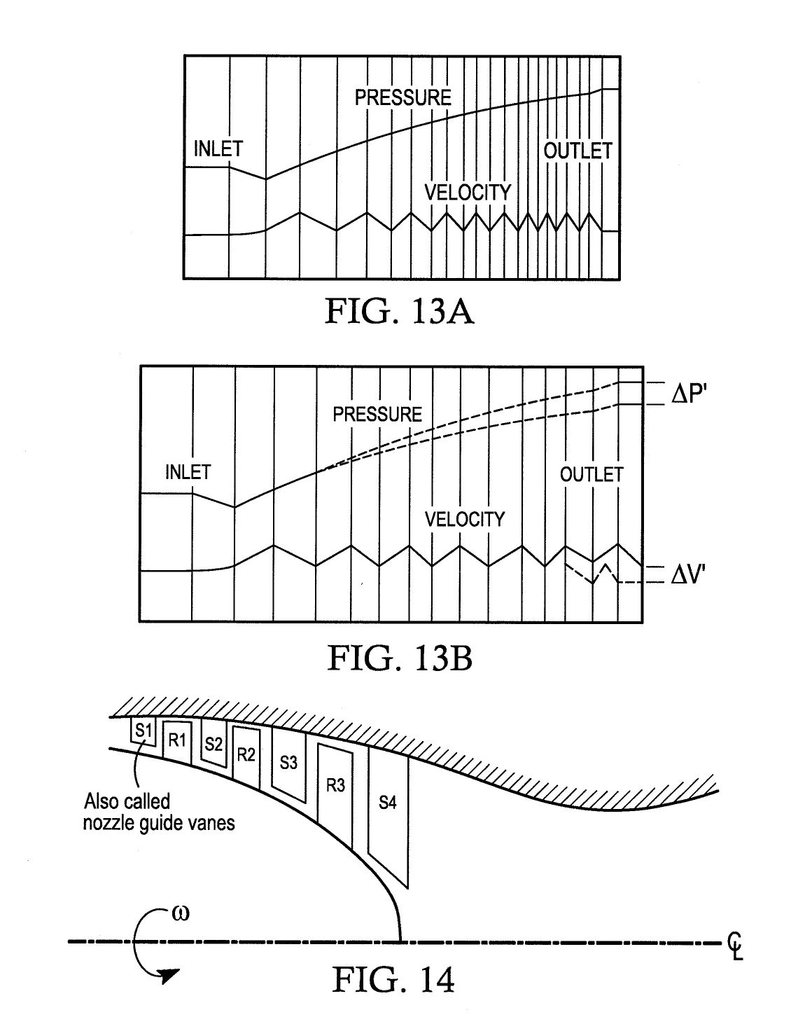

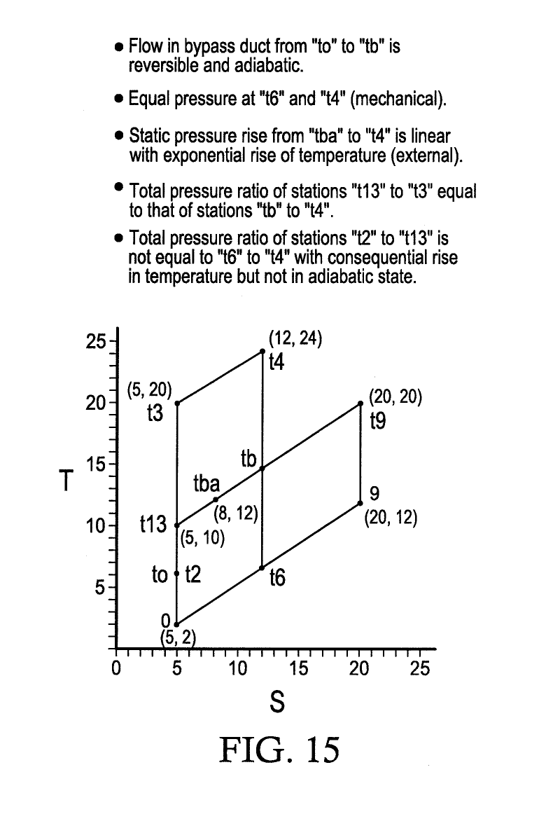

FIG. 11 depicts a multistage electric bypass fan and compressor unit that includes an inlet guide for guiding input air to the multi-stage bypass fan. The inlet guide may have inlet guide vanes that are configured and arranged to remove swirl and lower airflow velocity to the input air, creating laminar flow in the direction of the fan rotor rotation. The multi-stage bypass fan receives the air from the inlet guide and increases the velocity of the input air upto a predetermined value. For example, in one embodiment, an aircraft may be designed to cruise at Mach 1, or about 760 mph. The bypass fan will continue to accelerate input air to approximately this speed until the input air is moving at Mach 1 as well, i.e., when the aircraft has accelerated to the desired mach 1 cruising speed.

The multistage bypass fan has a plurality of stages, where each stage corresponds to an electrically driven fan rotors. In the preferred embodiment of the invention, each electrically driven fan motor is driven by one or more electric ring motors and is independently controllable. Ideally, each fan rotor may be rotated independently of any other fan rotor, although the fan rotors may be driven synchronously as well. The ring motor is disposed about the periphery of the corresponding fan rotor, with the result that the fan rotors are compressively loaded at all time. As discussed above the output air flow from the multistage bypass fan is at a higher velocity relative to the input air.

A diffuser portion is included between the multi-stage bypass fan and the multi-stage compressor, which discussed in more detail below. The diffuser has a smaller diameter than the bypass fan is designed to increase the air velocity, but lower its pressure. This allows the air flow to be managed for each stage.

The multistage compressor is coupled to the diffuser output and is sized and configured to receive only a portion of the output air flow from the diffuser. As in all bypass jet engines, a portion of the air flow from the bypass fan, bypasses the compressor and provides for a portion of the output power of the engine. The multi-stage compressor includes a plurality of compressor rotor and stator stages. Each stator and rotor combination forms one complete compressor stage. Each compressor rotor is driven by one or more electric ring motors disposed about the periphery of the rotor section. In this way, each compressor rotor section is able to be rotated independently of any other compressor rotor. Thus, each compressor rotor can be individually controlled, although it is a mode of operation to synchronously rotate some or all of the compressor rotors. In one embodiment, each compressor stator is driven at a higher rate of rotation than the compressor rotor in the preceding compression stage. Thus, the third output airflow will have a compression ratio of at least 12:1/In one embodiment where there are 8 compressor stages, the compression ratio can be in excess of 40:1. As with all bypass jet engines, a bypass path that is coupled to the output of the diffuser provides for a portion of the second output airflow around the periphery of the multistage compressor. Typically, the bypass fan is of a greater diameter than the compressor sections that follow it, and in some embodiments, each compressor stage has a smaller diameter than the preceding compressor stage. In general, the compressor includes a plurality of compressor stages where the size of the rotors in each stage is sized and dimensioned as a function of the compression ratio, mass air flow, thrust requirements, and desired flight envelope.

In one embodiment of the electric bypass fan and compressor a central hollow core is disposed upon a longitudinal axis of the bypass fan and compressor. This core, which is not load bearing as the bypass fan and compressor stages are loaded at the periphery due to be driven by individual ring motors, has a plurality of sections, some of which rotate independently of one another, and some of which are stationary. Each of the plurality of bypass fan rotors and each of the compressor rotors are coupled to the central core at rotating sections. Each of the compressor stators are stationary and affixed to the central core via non-rotating portions. The central core may includes a central passage located on the longitudinal axis that allows the flow through of 6.

1. An electric bypass fan and compressor comprising:
an inlet guide for guiding input air ;
a multistage bypass fan having an input for receiving guided input air from the inlet guide, the multi-stage bypass fan include a plurality of fan rotors, each fan rotor being rotatable independently of each other fan rotor, each of said fan rotor being driven by a corresponding ring motor arranged on the periphery of the corresponding fan rotor, wherein the multistage bypass fan is operative to provide a first output air flow of higher velocity air flow relative to the guided input air;
a diffuser portion having an input coupled to the first output airflow of the multistage bypass fan and operative to provide a second output air flow having a velocity higher than the first output airflow ;
a multistage compressor having an input coupled to the diffuser output and configured to receive a portion of the second output air flow, the multi-stage compressor including a plurality of compressor rotor and stator stages, forming a compressor stage, each compressor rotor being rotatable independently of each other compressor rotor, each of said compressor rotor being driven by a corresponding ring motor arranged on the periphery of the corresponding compressor rotor, and wherein a compressor stator is disposed between each compressor rotor wherein the multistage compressor is operative to provide an output of a third output air flow;
a bypass path coupled to the output of the diffuser and operative to provide a portion of fluid flow around the periphery of the multistage compressor.

2. The electric bypass fan and compressor according to claim 1 further comprising a central core being disposed upon a longitudinal axis of said bypass fan and compressor, said central core having a plurality of sections, each of said plurality of fan rotors and each of said plurality of compressor rotors being rotatably coupled to each central core and being associated with a corresponding rotatable portion of said central core, wherein said compressor stators are stationary and affixed to the central in a non-rotating portion, and wherein each rotor section is able to rotate independently of any other rotor section, and each stator section remains fixed and stationary,

3. The electric bypass fan and compressor according to claim 2, wherein said central core includes a flow through central passage located on said longitudinal axis.

4. The electric bypass fan and compressor according to claim 1, wherein each electric ring motor is independently controlled.

5. The electric bypass fan and compressor according to claim 1, wherein said plurality of fan rotors has a first dimension and said plurality of compressor rotors and stators have a second dimension, wherein said second dimension is less than said first dimension.

6. The electric bypass fan and compressor according to claim 2, wherein one of said plurality of fan rotors is driven by one or more ring motors.

7. The electric bypass fan and compressor according to claim 2, wherein one of said plurality of compressor rotors is driven by one or more ring motors.

8. The electric bypass fan and compressor according to claim 2, wherein each of said plurality of fan rotors may be driven at a unique velocity.

9. The electric bypass fan and compressor according to claim 2, wherein each of said plurality of compressor rotors may be driven at a unique velocity.

10. The electric bypass fan and compressor according to claim 2, wherein said plurality of compressor rotors sized and dimensioned as a function of the compression ratio, mass air flow, thrust requirements, and desired flight envelope.

11. The electric bypass fan and compressor according to claim 1 wherein the third output airflow has a compression ratio above 12:1.

12. The electric bypass fan and compressor according to claim 1 wherein the plurality of compressor stages equals eight and wherein the third output airflow from said multi-stage compressor has a compression ratio above 40:1.

12. The electric bypass fan and compressor according to claim 1, wherein said inlet guide has inlet guide vanes configured and arranged to remove swirl and airflow velocity to the input air, creating laminar flow in the direction of the fan rotor rotation.

13. The electric bypass fan and compressor according to claim 1, wherein each of the plurality of compressor stator is rotating at a higher rate than preceding compressor rotor, wherein each compressor stator is driven by a ring motor disposed about the periphery of said compressor stator.
